(19) United States
(12) Patent Application Publication
(10) Pub. No.: US 2019/0327159 A1
(43) Pub. Date: Oct. 24, 2019

(54) SYSTEMS AND METHODS FOR IDENTIFYING AND DISPLAYING LOGON DURATION METRICS

(71) Applicant: Nutanix, Inc., San Jose, CA (US)

(72) Inventor: Cornelis Hendrikus BAGGERMAN, Den Dolder (NL)

(21) Appl. No.: 15/958,649

(22) Filed: Apr. 20, 2018

(51) Int. Cl. H04L 12/26; H04L 12/24; H04L 29/08; G06F 9/455

(52) U.S. Cl. CPC H04L 43/0817; H04L 41/22; H04L 43/0811; G06F 11/3419; G06F 9/45558; G06F 2009/45591; H04L 67/306

(57) ABSTRACT

This disclosure provides systems and methods for determining a duration of a logon event. A start time of a logon event for a virtual machine can be identified. An end time of the logon event for the virtual machine can be identified. A duration of the logon event can be determined, based on a difference between the start time of the logon event and the end time of the logon event. A record including information corresponding to the duration of the logon event, an identification of the virtual machine, and an identification of a username associated with a user who initiated the logon event can be stored in a database. A visual representation of the stored record can be displayed via a graphical user interface.

### BACKGROUND

The following description is provided to assist the understanding of the reader. None of the information provided or references cited is admitted to be prior art.

Cloud computing architectures are widely used in a variety of applications. The underlying computer networks that support cloud computing can include hundreds or thousands of computing devices networked to form one or more clusters. In some instances, the computing devices may execute a large number of virtual machines and a large number of users may be given access to the virtual machines. The users may use the virtual machines by logging into operating systems hosted by the virtual machines. Metrics related to the duration of a logon event for each user can be an important factor in determining a quality of a user experience for the virtual machines.

### SUMMARY

In accordance with at least some aspects of the present disclosure, a method is disclosed. The method can include identifying, by a logon event monitoring circuit executing as part of a virtual machine, a start time of a logon event for a virtual machine. The method can include identifying, by the logon event monitoring circuit, an end time of the logon event for the virtual machine. The method can include determining, by the logon event monitoring circuit, a duration of the logon event based on a difference between the start time of the logon event and the end time of the logon event. The method can include storing, by a data management circuit, in a log database, a record including information corresponding to the duration of the logon event, an identification of the virtual machine, and an identification of a username associated with a user who initiated the logon event. The method can include displaying, by a graphical user interface circuit, a visual representation of the stored record.

In some embodiments, identifying the start time of the logon event can include identifying a time at which logon credentials of the user are successfully authenticated. In some embodiments, identifying the end time of the logon event can include identifying a time at which an operating system of the virtual machine is initialized such that the user can interact with the operating system.

In some embodiments, the method can include determining, by the logon event monitoring circuit, a second duration of a second logon event for the virtual machine. The method can also include storing, by the data management circuit, in the log database, a second record including information corresponding to the second duration of the second logon event. In some embodiments, the method can include determining, by the data management circuit, at least one metric associated with the logon event and the second logon event of the virtual machine. The method can also include displaying, by the graphical user interface circuit, a visual representation of the at least one metric. In some embodiments, the at least one metric can include at least one of a minimum logon duration, a maximum logon duration, and an average logon duration.

In some embodiments, the method can include determining, by a second logon event monitoring circuit executing as part of a second virtual machine, a second duration of a second logon event for the second virtual machine. The method can also include storing, by a second data management circuit, in the log database, a second record including information corresponding to the second duration of the second logon event. In some embodiments, the method can also include determining, by the logon event monitoring circuit, a duration of a sub-event included within the logon event. Storing the record in the log database can further include storing information corresponding to the duration of the sub-event. In some embodiments, the sub-event can include an event relating to loading a user profile associated with the user. In some embodiments, the method can include displaying the visual representation of the stored record via an HTML5 interface.

In accordance with some other aspects of the present disclosure, a system is disclosed. The system can include a logon event monitoring circuit executing as part of a virtual machine. The logon event monitoring circuit can be configured to identify a start time of a logon event for a virtual machine. The logon event monitoring circuit can be configured to identify an end time of the logon event for the virtual machine. The logon event monitoring circuit can be configured to determine a duration of the logon event based on a difference between the start time of the logon event and the end time of the logon event. The system can also include a data management circuit configured to store, in a log database, a record including information corresponding to the duration of the logon event, an identification of the virtual machine, and an identification of a username associated with a user who initiated the logon event. The system can also include a graphical user interface circuit configured to display a visual representation of the stored record.

In some embodiments, the logon event monitoring circuit can be further configured to identify the start time of the logon event by identifying a time at which logon credentials of the user are successfully authenticated. In some embodiments, the logon event monitoring circuit can be further configured to identify the end time of the logon event by identifying a time at which an operating system of the virtual machine is initialized such that the user can interact with the operating system.

In some embodiments, the logon event monitoring circuit is further configured to determine a second duration of a second logon event for the virtual machine. The data management circuit can be further configured to store, in the log database, a second record including information corresponding to the second duration of the second logon event. In some embodiments, the data management circuit can be further configured to determine at least one metric associated with the logon event and the second logon event of the virtual machine. The graphical user interface circuit can be further configured to display a visual representation of the at least one metric. In some embodiments, the at least one metric can include at least one of a minimum logon duration, a maximum logon duration, and an average logon duration.

In some embodiments, the system can include a second logon event monitoring circuit executing as part of a second virtual machine. The second logon event monitoring circuit can be configured to determine a second duration of a second logon event for the second virtual machine. The system can also include a second data management circuit configured to store, in the log database, a second record including information corresponding to the second duration of the second logon event.

In some embodiments, the logon event monitoring circuit can be further configured to determine a duration of a sub-event included within the logon event. The data management circuit can also be further configured to store the record in the log database to include information corresponding to the duration of the sub-event. In some embodiments, the sub-event can include an event relating to loading a user profile associated with the user. In some embodiments, the graphical user interface circuit can be further configured to display the visual representation of the stored record via an HTML5 interface.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing.

FIG. 1 is a block diagram of a virtual computing system, in accordance with some embodiments of the present disclosure.

FIG. 2 is a block diagram of a system for determining a duration of a logon event, in accordance with some embodiments of the present disclosure.

FIG. 3 is a diagram showing a sequence of sub-events in an event stream, in accordance with some embodiments of the present disclosure.

FIG. 4 is a flowchart of an example method for determining a duration of a logon event, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to computing environments that may include a plurality of virtual machines executing on a cluster of physical computing devices. For example, the plurality of virtual machines can be used by an organization such as a business to provide computer access for members of the organization. A user can access resources provided by a virtual machine by logging into the virtual machine with user credentials, such as a username and a password. In some embodiments, each user may be provided with a unique username or other identifying information. In some embodiments, a username may be shared by more than one user. The user credentials can be authenticated, which can cause a logon event to occur. Generally, a logon event can include any computing process or task performed in order to prepare an operating system for use by a user. For example, a logon event can include loading a user profile for the user, initializing the operating system, loading any number of computer applications, or displaying a desktop or other user interface element to allow the user to interact with the operating system.

The duration of a logon event can vary based on a variety of factors, such as the number and computational complexity of the computing processes that are performed during the logon event, as well as the capacity and performance of the computing resources (e.g., processors, memory, etc.) available for executing the processes. Because a user may not interact with the operating system until the logon event is complete, a long duration of a logon event can be frustrating for the user and can result in decreased efficiency for the organization that provides the virtual machine for use by the user. As a result, it can be useful to measure and record the duration of a logon event for a user. In addition, future logon events for the same user, as well as logon events for different users, can also be measured to determine their respective durations. Such information can be aggregated and provided for display (e.g., to a network administrator) to provide insight into the time required for various users to successfully logon to a virtual machine at various times and under various conditions. In some embodiments, additional metrics can also be generated, such as durations for individual processes or sub-events that make up a logon event, or metrics relating to a group of logon events (e.g., average duration for a group of logon events). These and other aspects of the disclosure are described in greater detail below.

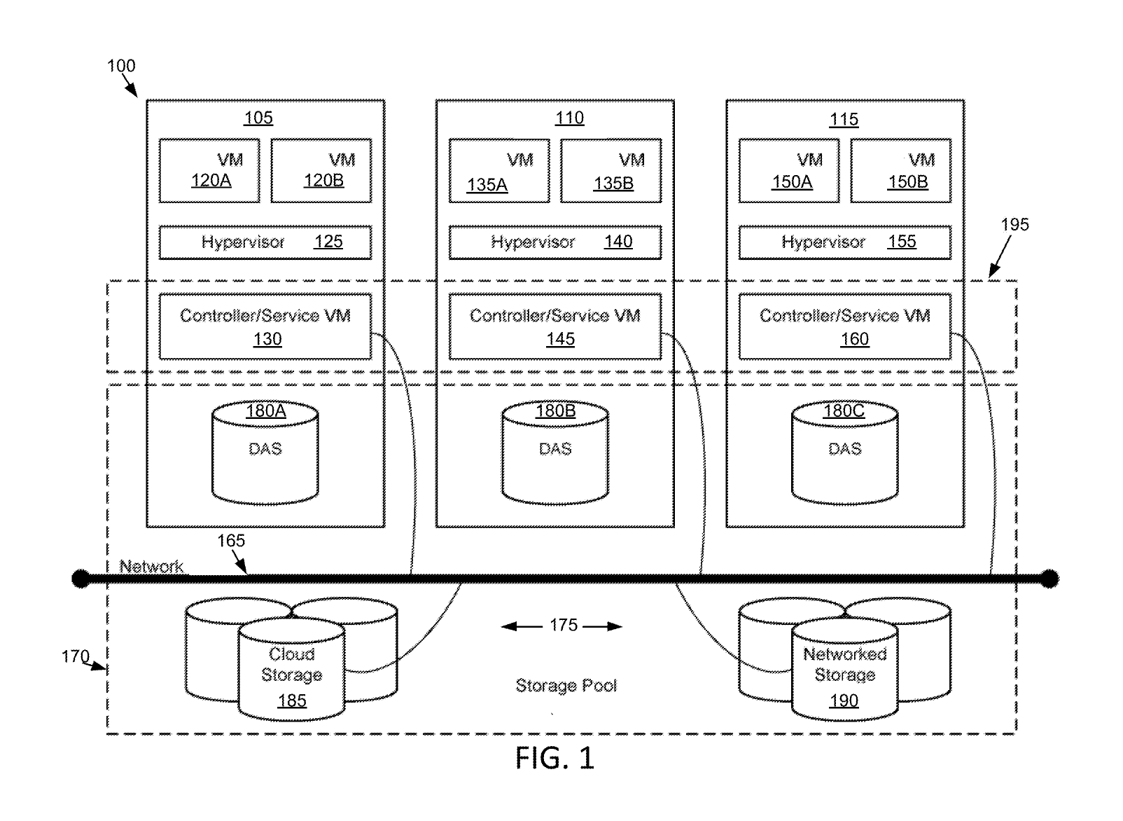

Referring now to FIG. 1, a virtual computing system 100 is shown, in accordance with some embodiments of the present disclosure. The virtual computing system 100 includes a plurality of nodes, such as a first node 105, a second node 110, and a third node 115. The first node 105 includes user virtual machines (“user VMs”) 120A and 120B (collectively referred to herein as “user VMs 120”), a hypervisor 125 configured to create and run the user VMs, and a controller/service VM 130 configured to manage, route, and otherwise handle workflow requests between the various nodes of the virtual computing system 100. Similarly, the second node 110 includes user VMs 135A and 135B (collectively referred to herein as “user VMs 135”), a hypervisor 140, and a controller/service VM 145, and the third node 115 includes user VMs 150A and 150B (collectively referred to herein as “user VMs 150”), a hypervisor 155, and a controller/service VM 160. The controller/service VM 130, the controller/service VM 145, and the controller/service VM 160 are all connected to a network 165 to facilitate communication between the first node 105, the second node 110, and the third node 115. Although not shown, in some embodiments, the hypervisor 125, the hypervisor 140, and the hypervisor 155 may also be connected to the network 165.

The virtual computing system 100 also includes a storage pool 170. The storage pool 170 may include network-attached storage 175 and direct-attached storage 180A, 180B, and 180C. The network-attached storage 175 may be accessible via the network 165 and, in some embodiments, may include cloud storage 185, as well as local storage area network 190. In contrast to the network-attached storage 175, which is accessible via the network 165, the direct-attached storage 180A, 180B, and 180C may include storage components that are provided within each of the first node 105, the second node 110, and the third node 115, respectively, such that each of the first, second, and third nodes may access its respective direct-attached storage without having to access the network 165.

It is to be understood that only certain components of the virtual computing system 100 are shown in FIG. 1. Nevertheless, several other components that are needed or desired in the virtual computing system to perform the functions described herein are contemplated and considered within the scope of the present disclosure. Additional features of the virtual computing system 100 are described in U.S. Pat. No. 8,601,473, the entirety of which is incorporated by reference herein.

Although three of the plurality of nodes (e.g., the first node 105, the second node 110, and the third node 115) are shown in the virtual computing system 100, in other embodiments, greater than or fewer than three nodes may be used. Likewise, although only two of the user VMs (e.g., the user VMs 120, the user VMs 135, and the user VMs 150) are shown on each of the respective first node 105, the second node 110, and the third node 115, in other embodiments, the number of the user VMs on each of the first, second, and third nodes may vary to include either a single user VM or more than two user VMs. Further, the first node 105, the second node 110, and the third node 115 need not always have the same number of the user VMs (e.g., the user VMs 120, the user VMs 135, and the user VMs 150). Additionally, more than a single instance of the hypervisor (e.g., the hypervisor 125, the hypervisor 140, and the hypervisor 155) and/or the controller/service VM (e.g., the controller/service VM 130, the controller/service VM 145, and the controller/service VM 160) may be provided on the first node 105, the second node 110, and/or the third node 115.

In some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100. In some embodiments, the virtual computing system 100 may be part of a data center.

Each of the first node 105, the second node 110, and the third node 115 may also be configured to communicate and share resources with each other via the network 165. For example, in some embodiments, the first node 105, the second node 110, and the third node 115 may communicate and share resources with each other via the controller/service VM 130, the controller/service VM 145, and the controller/service VM 160, and/or the hypervisor 125, the hypervisor 140, and the hypervisor 155. One or more of the first node 105, the second node 110, and the third node 115 may also be organized in a variety of network topologies, and may be termed as a “host” or “host machine.”

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 170, as well as with other elements of the first node 105, the second node 110, and the third node 115 to receive, send, and process information, and to control the operations of the underlying first, second, or third node. The processing units may retrieve a set of instructions from the storage pool 170, such as, from a permanent memory device like a read only memory (ROM) device and copy the instructions in an executable form to a temporary memory device that is generally some form of random access memory (RAM). The ROM and RAM may both be part of the storage pool 170, or in some embodiments, may be separately provisioned from the storage pool. Further, the processing units may include a single stand-alone processing unit, or a plurality of processing units that use the same or different processing technology.

With respect to the storage pool 170 and particularly with respect to the direct-attached storage 180A, 180B, and 180C, each of the direct-attached storage may include a variety of types of memory devices. For example, in some embodiments, one or more of the direct-attached storage 180A, 180B, and 180C may include, but is not limited to, any type of RAM, ROM, flash memory, magnetic storage devices (e.g., hard disk, floppy disk, magnetic strips, etc.), optical disks (e.g., compact disk (CD), digital versatile disk (DVD), etc.), smart cards, solid state devices, etc. Likewise, the network-attached storage 175 may include any of a variety of network accessible storage (e.g., the cloud storage 185, the local storage area network 190, etc.) that is suitable for use within the virtual computing system 100 and accessible via the network 165. The storage pool 170 including the network-attached storage 175 and the direct-attached storage 180A, 180B, and 180C may together form a distributed storage system configured to be accessed by each of the first node 105, the second node 110, and the third node 115 via the network 165, the controller/service VM 130, the controller/service VM 145, and the controller/service VM 160, and/or the hypervisor 125, the hypervisor 140, and the hypervisor 155. In some embodiments, the various storage components in the storage pool 170 may be configured as virtual disks for access by the user VMs 120, the user VMs 135, and the user VMs 150.

Each of the user VMs 120, the user VMs 135, and the user VMs 150 is a software-based implementation of a computing machine in the virtual computing system 100. The user VMs 120, the user VMs 135, and the user VMs 150 emulate the functionality of a physical computer. Specifically, the hardware resources, such as processing unit, memory, storage, etc., of the underlying computer (e.g., the first node 105, the second node 110, and the third node 115) are virtualized or transformed by the respective hypervisor 125, the hypervisor 140, and the hypervisor 155, respectively, into the underlying support for each of the user VMs 120, the user VMs 135, and the user VMs 150 that may run its own operating system and applications on the underlying physical resources just like a real computer. By encapsulating an entire machine, including CPU, memory, operating system, storage devices, and network devices, the user VMs 120, the user VMs 135, and the user VMs 150 are compatible with most standard operating systems (e.g. Windows, Linux, etc.), applications, and device drivers. Thus, each of the hypervisor 125, the hypervisor 140, and the hypervisor 155 is a virtual machine monitor that allows a single physical server computer (e.g., the first node 105, the second node 110, third node 115) to run multiple instances of the user VMs 120, the user VMs 135, and the user VMs 150, with each user VM sharing the resources of that one physical server computer, potentially across multiple environments. By running the user VMs 120, the user VMs 135, and the user VMs 150 on each of the first node 105, the second node 110, and the third node 115, respectively, multiple workloads and multiple operating systems may be run on a single piece of underlying hardware computer (e.g., the first node, the second node, and the third node) to increase resource utilization and manage workflow.

The user VMs 120, the user VMs 135, and the user VMs 150 are controlled and managed by their respective instance of the controller/service VM 130, the controller/service VM 145, and the controller/service VM 160. The controller/service VM 130, the controller/service VM 145, and the controller/service VM 160 are configured to communicate with each other via the network 165 to form a distributed system 195. Each of the controller/service VM 130, the controller/service VM 145, and the controller/service VM 160 may also include a local management system (e.g., Prism Element from Nutanix, Inc.) configured to manage various tasks and operations within the virtual computing system 100. For example, as discussed below, in some embodiments, the local management system of the controller/service VM 130, the controller/service VM 145, and the controller/service VM 160 may facilitate conversion of the hypervisor 125, the hypervisor 140, and the hypervisor 155 from a first hypervisor type to a second hypervisor type. The local management system may also manage the reconfiguration of the other components due to the conversion of the hypervisor.

The hypervisor 125, the hypervisor 140, and the hypervisor 155 of the first node 105, the second node 110, and the third node 115, respectively, may be configured to run virtualization software, such as, ESXi from VMWare, AHV from Nutanix, Inc., XenServer from Citrix Systems, Inc., etc., for running the user VMs 120, the user VMs 135, and the user VMs 150, respectively, and for managing the interactions between the user VMs and the underlying hardware of the first node 105, the second node 110, and the third node 115. Each of the controller/service VM 130, the controller/service VM 145, the controller/service VM 160, the hypervisor 125, the hypervisor 140, and the hypervisor 155 may be configured as suitable for use within the virtual computing system 100.

The network 165 may include any of a variety of wired or wireless network channels that may be suitable for use within the virtual computing system 100. For example, in some embodiments, the network 165 may include wired connections, such as an Ethernet connection, one or more twisted pair wires, coaxial cables, fiber optic cables, etc. In other embodiments, the network 165 may include wireless connections, such as microwaves, infrared waves, radio waves, spread spectrum technologies, satellites, etc. The network 165 may also be configured to communicate with another device using cellular networks, local area networks, wide area networks, the Internet, etc. In some embodiments, the network 165 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. The leader node may also be configured to receive and handle requests (e.g., user requests) from outside of the virtual computing system 100. If the leader node fails, another leader node may be designated. Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 170 may be part of the cluster as well. For example, the virtual computing system 100 as shown in FIG. 1 may form one cluster in some embodiments. Multiple clusters may exist within a given virtual computing system (e.g., the virtual computing system 100). The user VMs 120, the user VMs 135, and the user VMs 150 that are part of a cluster are configured to share resources with each other. In some embodiments, multiple clusters may share resources with one another.

Further, in some embodiments, although not shown, the virtual computing system 100 includes a central management system (e.g., Prism Central from Nutanix, Inc.) that is configured to manage and control the operation of the various clusters in the virtual computing system. In some embodiments, the central management system may be configured to communicate with the local management systems on each of the controller/service VM 130, the controller/service VM 145, the controller/service VM 160 for controlling the various clusters.

Again, it is to be understood again that only certain components of the virtual computing system 100 are shown and described herein. Nevertheless, other components that may be needed or desired to perform the functions described herein are contemplated and considered within the scope of the present disclosure. It is also to be understood that the configuration of the various components of the virtual computing system 100 described above is only an example and is not intended to be limiting in any way. Rather, the configuration of those components may vary to perform the functions described herein.

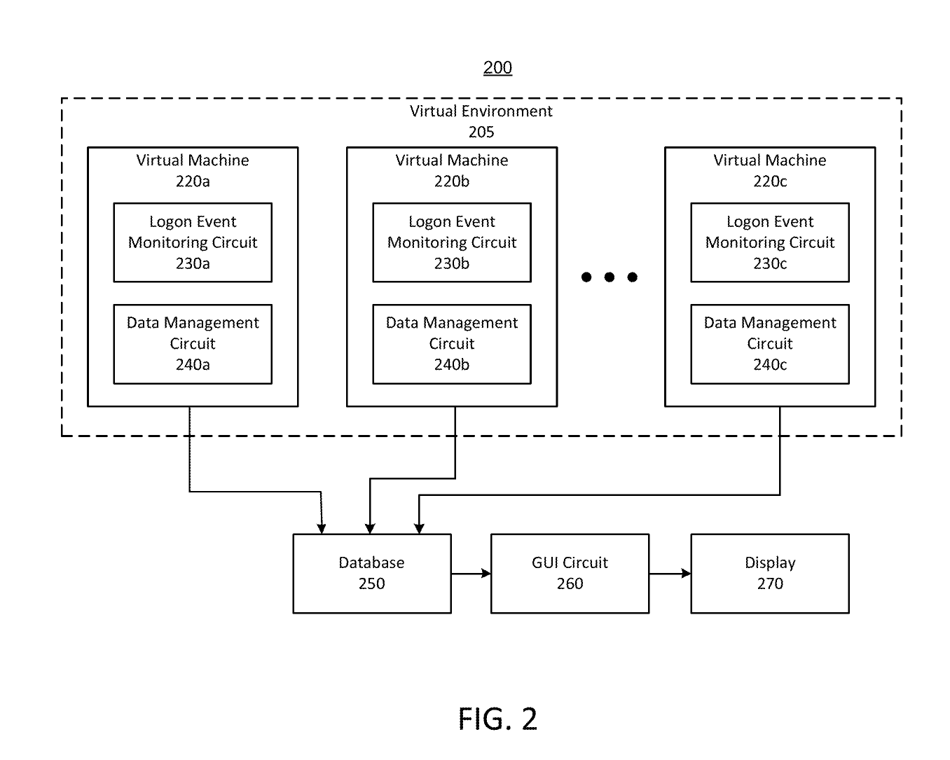

FIG. 2 is a block diagram of a system 200 for determining a duration of a logon event, in accordance with some embodiments of the present disclosure. The system 200 includes a virtual environment 205 that includes a plurality of virtual machines 220a-220c (generally referred to as virtual machines 220). Each virtual machine 220 includes a respective logon event monitoring circuit 230 and a respective data management circuit 240. The virtual machines 220 are coupled to a database 250. A graphical user interface (GUI) circuit 260 is coupled to the database 250 and to a display 270.

In some embodiments, the virtual machines 220 may correspond to any of the virtual machines 120, 135, or 150 shown in FIG. 1, or to the computing devices 105, 110, 115 shown in FIG. 1. It should be understood that the system 200 is simplified for illustrative purposes, and in practice may include any number of virtual machines 220, each of which may include a respective logon event monitoring circuit 230 and data management circuit 240.

Together, the logon event monitoring circuits 230 and data management circuits 240 can monitor and record information related to the duration of logon events that occur on their respective virtual machines 220. In some embodiments, a virtual machine 220 may be configured to be accessible to only a single user, and the logon event monitoring circuit 230 and data management circuit 240 of the virtual machine 220 may record information relating to logons by that user. In some other embodiments, a virtual machine 220 may be configured to provide access to a group of users, and the logon event monitoring circuit 230 and data management circuit 240 may be configured to record information relating to logons by any user of the group of users.

The logon event monitoring circuit 230 of each virtual machine 220 can be configured to determine a duration for a logon event for its respective virtual machine 220. For example, the logon event monitoring circuit 230 can determine a start time for a logon event and an end time for the logon event, and can determine the duration of the logon event as the difference between the start time and the end time. In some embodiments, the logon event monitoring circuit 230 may determine a start time for a logon event in real-time (i.e., at the time the user begins the logon process). The logon event can begin when the user initiates the logon event, for example by providing credentials such as a username and a password that are successfully authenticated. In some other embodiments, any other action that triggers the initialization of an operating system hosted by a virtual machine 220 can be considered as the beginning of the logon event. The logon event monitoring circuit 230 can continuously or periodically check for a trigger or event signaling the beginning of the logon process. In some embodiments, the logon event monitoring circuit 230 can determine the time at which the logon event started by referring to a timestamp provided by a clock that executes within the virtual machine 220 at the time the logon event begins. In some other embodiments, the logon event monitoring circuit 230 can determine the time based on a clock signal provided by the virtual environment 205, or by another external computing device to which the virtual machine 220 is coupled.

In some embodiments, the logon event monitoring circuit 230 can determine the start time for the logon event at a time in the future after the logon event is complete. For example, the logon event monitoring circuit 230 may refer to an audit log or other file that stores records of various events associated with the virtual machine 220, including logon events. Such a file may be stored in the database 250 or in another database within (or otherwise accessible by) the virtual machine 220. The logon event monitoring circuit 230 can parse the file to identify an entry corresponding to the beginning of a logon event, and can determine the start time based on a timestamp for that entry. For example, an entry in such a log that corresponds to successful authentication of user credentials may indicate the beginning of a logon event.

The logon event monitoring circuit 230 can determine the end time for the logon event in a manner similar to that used to determine the start time. For example, the logon event can end when the operating system that was initialized during the logon event becomes usable by the user, such as when a desktop, command line terminal, or other interface for interacting with the operating system is provided to the user. The logon event monitoring circuit 230 can continuously or periodically check for an event signaling the end of the logon process. In some embodiments, the logon event monitoring circuit 230 can determine the time at which the logon event ended by referring to a timestamp provided by a clock that executes within the virtual machine 220. In some other embodiments, the logon event monitoring circuit 230 can determine the time based on a clock provided by the virtual environment 205, or by another external computing device to which the virtual machine 220 is coupled. The logon event monitoring circuit 230 can also determine the end time for the logon event at a later time by referring to an audit log or other file that stores records of various events associated with the virtual machine 220. For example, the logon event monitoring circuit 230 can parse the file to identify an entry corresponding to the end of a logon event, and can determine the start time based on a timestamp for that entry.

The logon event monitoring circuit 230 can identify a duration of the logon event by determining a difference between the start time for the logon event and the end time for the logon event. In some embodiments, the data management circuit 240 can be configured to generate a record corresponding to the logon event. The record can include any of the information determined by the logon event monitoring circuit 230, such as the start time, end time, and duration of the logon event.

In addition, the data management circuit 240 can generate the record to include information relating to the particular virtual machine 220 on which the logon event was executed, or the particular user who initiated the logon event. For example, the data management circuit 240 can generate the record to include information such as a unique identifier for the virtual machine 220. The unique identifier for the virtual machine 220 can be an IP address associated with the virtual machine 220 or a hardware identifier such as a MAC address of the virtual machine 220. The data management circuit 240 can also generate the record to include a unique identifier for the user who initiated the logon event, such as a username of the user. In some embodiments, the record may also include additional information, such as an identification of the operating system initialized during the logon event, or a description of the computing resources (e.g., processors or memory devices) used to execute the processes that make up the logon event.

The data management circuit 240 can be configured to generate the record of a logon event in a variety of formats. For example, the data management circuit 240 can generate the record as an array, a vector, a linked list, or any other type of data structure capable of recording information corresponding to the duration of a logon event, as well as the other information described above that may be included in the record. The data management circuit 240 can also be configured to store the record in the database 250. In some embodiments, all of the logon event monitoring circuits 230 in the virtual environment 205 may be configured to monitor logon events on their respective virtual machines 220. As a result, over time, a large number of records of such logon events can be generated. In some embodiments, the data management circuits 240 can be configured to determine additional metrics related a group of logon events. For example, by referring to the stored records of a group of past logon events, a data management circuit 240 can determine an average, a minimum, or a maximum logon duration for the group of logon events. The data management circuit 240 can also be configured to store information corresponding to these metrics in the database 250.

The GUI circuit 260 can be configured to retrieve information from the database 250, generate display information based on the information retrieved from the database 250, and provide the display information to the display 270 for presentation to a user. In some embodiments, a user may interact with the GUI circuit 260 to request certain information to be displayed based on one or more search parameters. For example, the GUI circuit 260 can be configured to retrieve logon event duration records from the database according to parameters such as a range of dates or times during which the logon events took place, a subset of the virtual machines 220 that experienced logon events, a user or group of users who initiated logon events. The GUI circuit 260 can manipulate the records it retrieves from the database 250, for example to format the information in a manner that allows it to be displayed by the display 270. In some embodiments, the GUI circuit 260 can format the information for display as part of an HTML5 interface. In some embodiments, the GUI circuit 260 can format the information to be displayed in the form of graphs, charts, tables alphanumeric characters, or any combination of these. The GUI circuit 260 can transmit the formatted information to the display 270, which can be configured to display the formatted information to a viewer such as a network administrator. In some embodiments, the display 270 can be a television a computer monitor, or an electronic display of a mobile computing device, tablet computing device, or laptop computer.

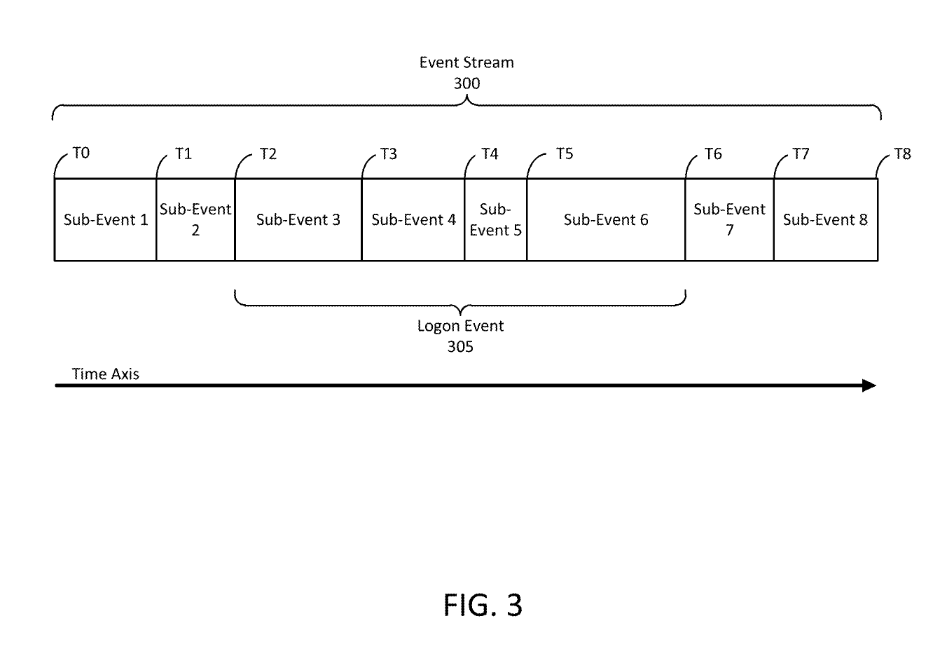

FIG. 3 is a diagram showing a sequence of sub-events in an event stream 300, in accordance with some embodiments of the present disclosure. In FIG. 3, a time axis is provided in a left-to-right direction. Eight sub-events are shown, each with a respective start time and end time. Each sub-event is adjacent to the sub-events immediately preceding and succeeding it, such that there are no gaps between sub-events in the event stream 300. For example, as illustrated, sub-event 1 begins at time T0 and ends at time T1, sub-event 2 begins at time T1 and ends at time T2, sub-event 3 begins at time T2 and ends at time T3, sub-event 4 begins at time T3 and ends at time T4, sub-event 5 begins at time T4 and ends at time T5, sub-event 6 begins at time T5 and ends at time T6, sub-event 7 begins at time T6 and ends at time T7, and sub-event 8 begins at time T7 and ends at time T8. Also as illustrated, the sub-events may have durations that differ from one another. However, it should be understood that the sub-events shown in FIG. 3 are illustrative only and that generally, an event stream such as the event stream 300 may include any number of sub-events, each of which may have any time duration.

The sub-events of the event stream 300 can each correspond to any process or task performed by the virtual machines 220 within the virtual environment 205 of FIG. 2. Accordingly, the event stream 300 can be used to visualize the process by which the logon event monitoring circuit 230 of FIG. 2 can determine a duration of a logon event. For example, within the event stream 300, a group of sub-events including sub-event 3, sub-event 4, sub-event 5, and sub-event 6 together can form a logon event 305. As described above, a logon event can include any number of sub-events, which may correspond to processes such as loading a user profile, initializing an operating system, rendering a desktop or other user interface element for display to a user, and the like. In the example of FIG. 3, the logon event 305 includes four sub-events, but in other embodiments the logon event 305 may include more or fewer sub-events. The logon event monitoring circuit 230 can determine the start time of the logon event 305 based on the time at which the first sub-event of the logon event 305 occurs. In FIG. 3, the start time of the logon event 305 is T2. Similarly, the logon event monitoring circuit 230 can determine the end time for the logon event 305 based on the time at which the last sub-event of the logon event 305 occurs. Therefore, in FIG. 3, the end time for the logon event 305 is T6.

The logon event monitoring circuit 230 can determine the duration of the logon event 305 by subtracting T2 from T6. In addition, the logon event monitoring circuit 230 can be configured to determine durations for any of the sub-events included within the logon event 305 (i.e., sub-event 3, sub-event 4, sub-event 5, and sub-event 6). The logon event monitoring circuit 230 can determine the duration of these subevents in a manner similar to that used to determine the duration of the overall logon event 305 by finding the difference between the time at which each sub-event begins and ends. In some embodiments, the data management circuit 240 can be configured to store information corresponding to the sub-events of the logon event 305 in the record that it generates for the logon event 305. For example, the data management circuit 240 can generate the record to include an identification of each sub-event, along with its respective duration, within the record for the logon event 305. The data management circuit 240 can also store all of this information in the database 250.

In some embodiments, having a record of the sub-events of a group of logon events 305 can be useful for a network administrator because it may provide insight into the components of logon events that contribute disproportionately to the overall duration of the logon events. For example, it may be discovered that a particular type of sub-event makes up a disproportionate amount of the overall duration of logon events. As a result, that sub-event may be modified to reduce the time it takes for the sub-event to be completed, or the sub-event may be removed entirely from the logon process (e.g., if it is an optional sub-event that is not required to complete a logon) in order to save time on logon events in the future.

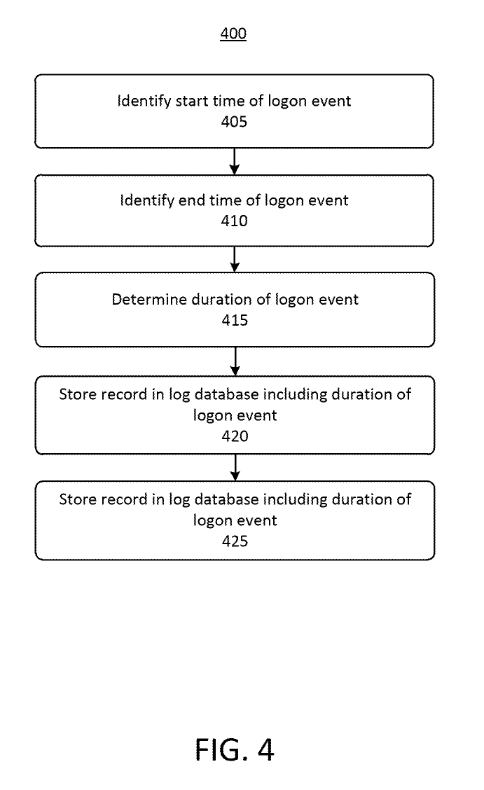

FIG. 4 is a flowchart of an example method 400 for determining a duration of a logon event, in accordance with some embodiments of the present disclosure. In brief overview, the method 400 includes identifying a start time of a logon event (step 405), identifying an end time of the logon event (step 410), determining a duration of the logon event (step 415), storing a record including the duration of the logon event in a log database (step 420), and displaying a visual representation of the stored record (step 425).

Referring again to FIG. 4, the method 400 includes identifying a start time of a logon event (step 405). In some embodiments, this can be performed by the logon event monitoring circuit 230 of any of the virtual machines 220 of FIG. 2. The logon event monitoring circuit 230 can determine the start time based on the start time of an event (or sub-event) of the logon event that occurs at the beginning of the logon event. For example, the logon event monitoring circuit 230 may determine the start time as the time at which credentials, such as a username and password, are successfully authenticated to trigger the logon event to begin.

The method 400 also includes identifying an end time of the logon event (step 410). In some embodiments, the logon event monitoring circuit 230 can be configured to determine the end time based on the end time of an event or sub-event of the logon event that occurs at the end of the logon event. For example, the end of the logon event can be the time at which the user can interact with the operating system. A sub-event that coincides with this, such as a sub-event relating to rendering a desktop or other interface element for display to the user, be used to signal the end time of the logon event. The method 400 also includes determining a duration of the logon event (step 415). In some embodiments, the logon event monitoring circuit 230 can be configured to determine the duration of the logon event by determining a difference between the start time of the logon event and the end time of the logon event. In some embodiments, the logon event monitoring circuit 230 can also determine durations for any sub-events included in the logon event in a similar manner.

The method 400 also includes storing a record including the duration of the logon event in a log database (step 420). In some embodiments, the data management circuit 240 of any of the virtual machines 220 shown in FIG. 2 can be configured to generate a record corresponding to a logon event. The record can include any of the information determined by the logon event monitoring circuit 230, such as the start time, end time, and duration of the logon event. The record can also include information relating to the particular virtual machine 220 on which the logon event was executed, or the particular user who initiated the logon event. In some embodiments, the record may also include additional information, such as an identification of the operating system initialized during the logon event, or a description of the computing resources (e.g., processors or memory devices) used to execute the processes (which may correspond to sub-events) that make up the logon event.

The method 400 also includes displaying a visual representation of the stored record (step 425). In some embodiments, the GUI circuit 260 shown in FIG. 2 can be configured to retrieve the records from the log database, such as the database 250. The GUI circuit 260 can also be configured to generate display information based on the records it retrieves from the database 250. In some embodiments, the GUI circuit 260 can be configured to retrieve logon event duration records from the database according to search parameters such as a range of dates or times during which the logon events took place or a group of users who initiated logon events. The GUI circuit 260 can manipulate the records it retrieves from the database 250, for example to format the information in a manner that allows it to be displayed by the display 270. In some embodiments, the GUI circuit 260 can format the information for display as part of an HTML5 interface. The GUI circuit 260 can then provide the formatted information to a display device to cause the information to be presented visually to a user, such as a network administrator.

Although the present disclosure has been described with respect to software applications, in other embodiments, one or more aspects of the present disclosure may be applicable to other components of the virtual computing system 100 that may be suitable for real-time monitoring by the user.

It is also to be understood that in some embodiments, any of the operations described herein may be implemented at least in part as computer-readable instructions stored on a computer-readable memory. Upon execution of the computer-readable instructions by a processor, the computer-readable instructions may cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method comprising:
identifying, by a logon event monitoring circuit executing as part of a virtual machine, a start time of a logon event for a virtual machine;
identifying, by the logon event monitoring circuit, an end time of the logon event for the virtual machine;
determining, by the logon event monitoring circuit, a duration of the logon event based on a difference between the start time of the logon event and the end time of the logon event; and
storing, by a data management circuit, in a log database, a record including information corresponding to the duration of the logon event, an identification of the virtual machine, and an identification of a username associated with a user who initiated the logon event.

2. The method of claim 1, wherein identifying the start time of the logon event comprises identifying a time at which logon credentials of the user are successfully authenticated.

3. The method of claim 1, wherein identifying the end time of the logon event comprises identifying a time at which an operating system of the virtual machine is initialized such that the user can interact with the operating system.

4. The method of claim 1, further comprising:
determining, by the logon event monitoring circuit, a second duration of a second logon event for the virtual machine; and
storing, by the data management circuit, in the log database, a second record including information corresponding to the second duration of the second logon event.

5. The method of claim 4, further comprising:
determining, by the data management circuit, at least one metric associated with the logon event and the second logon event of the virtual machine.

6. The method of claim 5, wherein the at least one metric comprises at least one of a minimum logon duration, a maximum logon duration, and an average logon duration.

7. The method of claim 1, further comprising:
determining, by a second logon event monitoring circuit executing as part of a second virtual machine, a second duration of a second logon event for the second virtual machine; and
storing, by a second data management circuit, in the log database, a second record including information corresponding to the second duration of the second logon event.

8. The method of claim 1, further comprising:
determining, by the logon event monitoring circuit, a duration of a sub-event included within the logon event, wherein storing the record in the log database further comprises storing information corresponding to the duration of the sub-event.

9. The method of claim 1, wherein the sub-event includes an event relating to loading a user profile associated with the user.

10. The method of claim 1, further comprising displaying the visual representation of the stored record via an HTML5 interface.

11. A system for identifying logon duration metrics, comprising:
a logon event monitoring circuit executing as part of a virtual machine, the logon event monitoring circuit having programmed instructions to:
identify a start time of a logon event for a virtual machine;
identify an end time of the logon event for the virtual machine; and
determine a duration of the logon event based on a difference between the start time of the logon event and the end time of the logon event; and
a data management circuit having programmed instructions to store, in a log database, a record including information corresponding to the duration of the logon event, an identification of the virtual machine, and an identification of a username associated with a user who initiated the logon event.

12. The system of claim 11, wherein the logon event monitoring circuit further identifies the start time of the logon event by identifying a time at which logon credentials of the user are successfully authenticated.

13. The system of claim 11, wherein the logon event monitoring circuit further identifies the end time of the logon event by identifying a time at which an operating system of the virtual machine is initialized such that the user can interact with the operating system.

14. The system of claim 11, wherein:
the logon event monitoring circuit further determines a second duration of a second logon event for the virtual machine; and
the data management circuit further stores, in the log database, a second record including information corresponding to the second duration of the second logon event.

15. The system of claim 14, wherein:
the data management circuit further determines at least one metric associated with the logon event and the second logon event of the virtual machine.

16. The system of claim 15, wherein the at least one metric comprises at least one of a minimum logon duration, a maximum logon duration, and an average logon duration.

17. The system of claim 11, further comprising:
a second logon event monitoring circuit executing as part of a second virtual machine, the second logon event monitoring circuit determines a second duration of a second logon event for the second virtual machine; and
a second data management circuit stores, in the log database, a second record including information corresponding to the second duration of the second logon event.

18. The system of claim 11, wherein:
the logon event monitoring circuit further determines a duration of a sub-event included within the logon event; and
the data management circuit further stores the record in the log database to include information corresponding to the duration of the sub-event.

19. The system of claim 11, wherein the sub-event includes an event relating to loading a user profile associated with the user.

20. The system of claim 11, wherein the graphical user interface circuit displays the visual representation of the stored record via an HTML5 interface.
